(19) United States
(12) Patent Application Publication
(10) Pub. No.: US 2015/0237524 A1
(43) Pub. Date: Aug. 20, 2015

(54) METHOD FOR TRANSMITTING AUDIO INFORMATION AND PACKET COMMUNICATION SYSTEM

(71) Applicant: NEC Corporation, Minato-ku, Tokyo (JP)

(72) Inventor: Kazunori Ozawa, Tokyo (JP)

(73) Assignee: NEC CORPORATION, Minato-ku, Tokyo (JP)

(21) Appl. No.: 14/431,437

(22) PCT Filed: Sep. 4, 2013
(86) PCT No.: PCT/JP2013/074442

§ 371 Date: Mar. 26, 2015

(30) Foreign Application Priority Data
Sep. 27, 2012 (JP) 2012-214530

(51) Int. Cl. H04W 28/02; H04W 24/08; H04L 12/26; H04L 12/801

(52) U.S. Cl. CPC H04W 28/02; H04L 47/10; H04W 24/08; H04L 43/0852

(57) ABSTRACT

Audio information is transmitted from a transmission node as packets (P₁, P₂, . . . , Pₘ) having data amounts (q₁, q₂, . . . , qₘ) that satisfy a relationship of q₁<q₂< . . . <qₘ. A reception node selects one of the packets based on delay times (t₁, t₂, . . . , tₘ) of the packets (P₁, P₂, . . . , Pₘ).

### TECHNICAL FIELD

This invention relates to transmission of audio information through use of packet communication. In particular, this invention relates to transmission of audio information through use of packet communication via a data communication network including, in at least a part thereof, a wireless communication section such as a mobile communication network.

### BACKGROUND ART

When audio information is encoded and transmitted via a packet communication network, a packet delay occurs in some cases depending on a traffic congestion situation of the packet communication network. In particular, in a case of mobile communication such as mobile phone communication, its traffic congestion situation varies greatly depending on the locations of terminals and time.

Accordingly, when the traffic congestion situation is assumed before communication and a data rate corresponding to a bandwidth that is usable under the assumed congestion situation is determined in advance, and the audio information is encoded and packetized to be transmitted at the determined data rate, a bit rate suitable for an actual traffic congestion situation is not necessarily achieved. When the actual traffic is more congested than the assumed one, the packet delay occurs and a real-time characteristic is thus deteriorated. In contrast, when the actual traffic is less congested than the assumed one, an opportunity for transmission at a high bit rate at which data could have been transmitted under this actual traffic situation without a delay is missed as a result.

In recent years, in corporations and the like in particular, the use of a “thin client” starts to become widespread in order to ensure high-level security. The thin client is a technology with which a virtual client on a server is operated from a terminal as if an actual terminal were operated and an application is run through use of the virtual client to generate screen information, and the screen information is transferred to the terminal to be displayed on a screen of the terminal. The thin client has an advantage in that because no data remains in a terminal, there is no fear of leakage of secret information, corporate information, and the like to the outside even if the terminal is lost.

### PRIOR ART DOCUMENT

### Patent Document

### Patent Document 1: JP-A-2005-39724

### SUMMARY OF THE INVENTION

### Problem to be Solved by the Invention

The above-mentioned problem also arises even when such a thin client is used to make a voice call under VoIP. The problem is, specifically, as follows. In a mobile network or the Internet, a bandwidth for the network is relatively narrow, and further, the bandwidth varies temporally depending on a traffic congestion situation. When the bandwidth becomes narrower, voice data remains on the network and a delay time that elapses before the voice data arrives at a client becomes longer, which makes it difficult to make a call.

Patent Document 1 is given as a document in which the art related to this invention is disclosed. In Patent Document 1, there is disclosed a system including: terminals A and B capable of dynamically switching one or a plurality of speech coding schemes; and a speech coding scheme converter having a SIP control function. In this system, the speech coding scheme converter having the SIP control function dynamically switches, mutually converts, and relays the speech coding schemes of the terminals A and B, to thereby prevent termination of communication due to a bandwidth shortage.

This invention has been made in view of the above-mentioned circumstances, and it is an object of this invention to transmit, when audio information is transmitted via a packet communication network, the audio information without causing a delay and as higher-quality data in response to a temporal variation of traffic of the packet communication network.

### Means to Solve the Problem

In order to solve the above-mentioned problem, according to one aspect of this invention, there is provided a packet communication system, including: a first node; and a second node, the first node including: packet generation means for encoding audio information to be transmitted to generate a plurality of packets P₁, P₂, . . . , Pₘ, the plurality of packets P₁, P₂, . . . , Pₘ each corresponding to the audio information and having data amounts q₁, q₂, . . . , qₘ, respectively, that satisfy a relationship of q₁<q₂< . . . <qₘ, where m is a natural number of 2 or more; and packet transmission means for transmitting the plurality of packets P₁, P₂, . . . , Pₘ to the second node, which is different from the first node, via a packet communication network, the second node including: delay time measurement means for measuring delay times t₁, t₂, . . . , tₘ of the plurality of packets P₁, P₂, . . . , Pₘ, respectively; and packet selection means for selecting any one of the plurality of packets P₁, P₂, . . . , Pₘ based on the delay times t₁, t₂, . . . , tₘ.

Further, according to another aspect of this invention, there is provided a packet communication device, including: packet reception means for receiving a plurality of packets P₁, P₂, . . . , Pₘ via a packet communication network, the plurality of packets P₁, P₂, . . . , Pm each corresponding to the audio information, each of the audio information to be transmitted being encoded to the plurality of packets P₁, P₂, . . . , Pₘ, and the plurality of packets P₁, P₂, . . . , Pₘ having data amounts q₁, q₂, . . . , qₘ, respectively, that satisfy a relationship of q₁<q₂< . . . <qₘ, where m is a natural number of 2 or more; delay time measurement means for measuring delay times t₁, t₂, . . . , tₘ of the plurality of packets P₁, P₂, . . . , Pₘ, respectively; and packet selection means for selecting any one of the plurality of packets P₁, P₂, . . . , Pₘ based on the delay times t₁, t₂, . . . , tₘ.

Further, according to still another aspect of this invention, there is provided a packet communication device, including: packet generation means for encoding audio information to be transmitted to generate a plurality of packets P₁, P₂, . . . , Pₘ, the plurality of packets P₁, P₂, . . . , Pₘ each corresponding to the audio information and having data amounts q₁, q₂, . . . , qₘ, respectively, that satisfy a relationship of q₁<q₂< . . . <qₘ, where m is a natural number of 2 or more; and packet transmission means for transmitting the plurality of packets P₁, P₂, . . . , Pₘ to a destination packet communication device, which is different from the packet communication device, via a packet communication network. The destination packet communication device is configured to: measure delay times t₁, t₂, . . . , tₘ of the plurality of packets P₁, P₂, . . . , Pₘ, respectively; and select any one of the plurality of packets P₁, P₂, . . . , Pₘ based on the delay times t₁, t₂, . . . , tₘ.

Further, according to yet another aspect of this invention, there is provided a program for causing a computer to function as: packet reception means for receiving a plurality of packets P₁, P₂, . . . , Pₘ via a packet communication network, the plurality of packets P₁, P₂, . . . , Pm each corresponding to the audio information, each of the audio information to be transmitted being encoded to the plurality of packets P₁, P₂, . . . , Pₘ, and the plurality of packets P₁, P₂, . . . , Pₘ having data amounts q₁, q₂, . . . , qₘ, respectively, that satisfy a relationship of q₁<q₂< . . . <qₘ, where m is a natural number of 2 or more; delay time measurement means for measuring delay times t₁, t₂, . . . , tₘ of the plurality of packets P₁, P₂, . . . , Pₘ, respectively; and packet selection means for selecting any one of the plurality of packets P₁, P₂, . . . , Pₘ based on the delay times t₁, t₂, . . . , tₘ.

Further, according to yet another aspect of this invention, there is provided a program for causing a computer to function as: packet generation means for encoding audio information to be transmitted to generate a plurality of packets P₁, P₂, . . . , Pₘ, the plurality of packets P₁, P₂, . . . , Pₘ each corresponding to the audio information and having data amounts q₁, q₂, . . . , qₘ, respectively, that satisfy a relationship of q₁<q₂< . . . <qₘ, where m is a natural number of 2 or more; and packet transmission means for transmitting the plurality of packets P₁, P₂, . . . , Pₘ to a destination packet communication device, which is different from the packet communication device, via a packet communication network. The destination packet communication device is configured to: measure delay times t₁, t₂, . . . , tₘ of the plurality of packets P₁, P₂, . . . , Pₘ, respectively; and select any one of the plurality of packets P₁, P₂, . . . , Pₘ based on the delay times t₁, t₂, . . . , tₘ.

Further, according to yet another aspect of this invention, there is provided a method of transmitting audio information, including, when transmitting audio information from a first node to a second node via a packet communication network: a packet generation step of encoding, by the first node, audio information to be transmitted to generate a plurality of packets P₁, P₂, . . . , Pₘ, the plurality of packets P₁, P₂, . . . , Pₘ each corresponding to the audio information and having data amounts q₁, q₂, . . . , qₘ, respectively, that satisfy a relationship of q₁<q₂< . . . <qₘ, where m is a natural number of 2 or more; a packet transmission step of transmitting the plurality of packets P₁, P₂, . . . , Pₘ from the first node to the second node via the packet communication network; a delay time measurement step of measuring, by the second node, delay times t₁, t₂, . . . , tₘ of the plurality of packets P₁, P₂, . . . , Pₘ, respectively; and a packet selection step of selecting, by the second node, any one of the plurality of packets P₁, P₂, . . . , Pₘ based on the delay times t₁, t₂, . . . , tₘ.

### Effect of the Invention

According to one embodiment of this invention, the node on the transmission side transmits the one piece of audio information as the plurality of packets having the data amounts that are different from one another, and the node on the reception side selects the packet having the largest data amount from among the packets that have been received without a delay or within the allowable delay time and decodes the audio information of the selected packet. Accordingly, it is possible to transmit the audio information at a higher bit rate within such a range as to enable the transmission without a delay under the congestion situation of the packet communication network at a given time.

### BRIEF DESCRIPTION OF THE DRAWING

FIG. 1 is a block diagram illustrating an audio information transmission system 1 according to one embodiment of this invention.

FIG. 2 is a block diagram of a remote mobile communication system 100 according to a second embodiment of this invention.

FIG. 3 is a block diagram of a server machine 110.

FIG. 4 is a block diagram of a voice determination/transfer unit 185.

FIG. 5 is a block diagram of a portable terminal 170_1.

### MODES FOR EMBODYING THE INVENTION

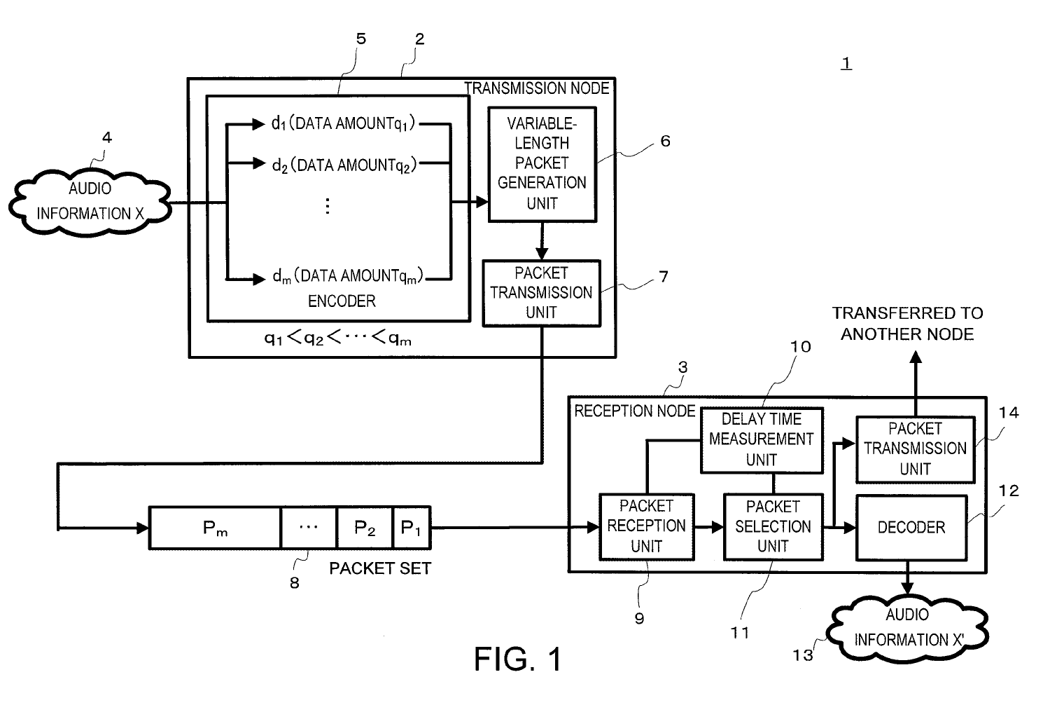

A description is given of an audio information transmission system 1 according to a first embodiment of this invention with reference to FIG. 1. The audio information transmission system 1 includes a transmission node 2 and a reception node 3.

The transmission node 2 is a packet communication device for encoding and packetizing audio information X 4 input thereto and transmitting the resultant audio information to the reception node 3 via a packet communication network. Specifically, the transmission node 2 is preferably a wireless communication device for performing packet data communication, such as a mobile phone terminal, but may also be a server machine or a client device installed on a network such as the Internet. The transmission node 2 includes an encoder 5, a variable-length packet generation unit 6, and a packet transmission unit 7.

The encoder 5 encodes the audio information X 4, and in encoding the audio information X 4, generates a plurality of pieces of data d₁, d₂, . . . , dₘ (where m is a natural number of 2 or more) corresponding to one piece of audio information X 4. When it is assumed in this case that data amounts of the pieces of data d₁, d₂, . . . , dₘ are represented by data amounts q₁, q₂, . . . , qₘ, respectively, the encoder 5 generates the pieces of data so that a relationship of q₁<q₂< . . . <qₘ holds. For example, in a case where m=5, the encoder 5 encodes the audio information X 4 at bit rates of 32 kbps, 40 kbps, 48 kbps, 56 kbps, and 64 kbps to generate pieces of data d₁, d₂, . . . , d₅, respectively.

The variable-length packet generation unit 6 generates variable-length packets each having a packet length corresponding to the data amount. The variable-length packet generation unit 6 generates packets P₁, P₂, . . . , Pₘ corresponding to the pieces of data d₁, d₂, . . . , dₘ, respectively. The generated packets are variable-length packets, and hence a magnitude relation among data amounts of the packets P₁, P₂, . . . , Pₘ inherits a magnitude relation among the pieces of data d₁, d₂, . . . , dₘ as it is.

The packet transmission unit 7 transmits the packets P₁, P₂, . . . , Pₘ to the packet communication network in this stated order. The packet transmission unit 7 transmits a packet set 8 that corresponds to the audio information X 4 and includes m packets whose data amounts are different from one another to the reception node 3 in ascending order of the data amounts. An order relation of the transmitted packets is illustrated as the packet set 8.

The reception node 3 may also preferably be a server machine or a client device installed on the network such as the Internet. Alternatively, the reception node 3 may also be a wireless communication device for performing packet data communication, such as a mobile phone terminal. In the reception node 3, when a packet reception unit 9 receives the packet set 8, a delay time measurement unit 10 measures a delay time for each packet. The packet transmission unit 7 transmits the packets P₁, P₂, . . . , Pₘ in this stated order, and hence the packet reception unit 8 basically receives the packets P₁, P₂, . . . , Pₘ in this stated order. It is assumed here that delay times of the packets P₁, P₂, . . . , Pₘ are represented by t₁, t₂, . . . , tₘ, respectively. A packet selection unit 11 selects and outputs a packet having the largest data amount from among the packets each having an allowable delay time based on the delay times t₁, t₂, . . . , tₘ and the data amounts of the corresponding packets.

In general, the delay time on the network of the packet having a smaller data amount is conceivably shorter, and in contrast, the delay time on the network of the packet having a larger data amount is conceivably longer. In view of this point, a conceivable case is where the packet selection unit 11 sequentially determines the delay times of the packets P₁, P₂, . . . , Pₘ, which have been received in this stated order, and when determining that the delay time of a given packet exceeds an allowable range, selects a packet received immediately before the given packet. In this case, packets received afterwards may be discarded without being subjected to the determination based on their delay times.

For example, when it is assumed that the determination is made based on the delay time t₃ of the packet P₃ and it is determined that the packet P₃ is significantly delayed, the packet selection unit 11 selects the packet P₂, which has been received immediately before the packet P₃. As described above, the delay time of the packet having a smaller data amount is conceivably shorter. It is thus conceivable that unless a traffic congestion situation suddenly changes, the fact that, within the packet set corresponding to the audio information X 4, the packets P₁ and P₂ received earlier are not detected to be significantly delayed and the packet P₃ is detected to be significantly delayed means that the packets P₄, P₅, . . . , Pₘ to be received afterwards are significantly delayed. In view of this idea, the determination based on the delay time may be omitted for the packet P₄ and packets to be received afterwards, or instead, the packets themselves may be discarded.

Further, the packets P₁, P₂, . . . , Pₘ are transmitted in ascending order of their data amounts, and hence the packet received immediately before the packet determined as being significantly delayed has the largest data amount among the packets that have been received with a small delay. For example, as in the above-mentioned case, it is assumed that m=5 and the pieces of data d₁, d₂, . . . , d₅ of the audio information X 4 are encoded and packetized at the bit rates of 32 kbps, 40 kbps, 48 kbps, 56 kbps, and 64 kbps, respectively, and then the resultant packets are transmitted. It is assumed in this case that the packet P₃, which is m=3 and stores the data d₃ encoded at the data rate of 48 kbps, has the delay time t₃ and the packet selection unit 11 determines that the packet P₃ is significantly delayed. At this time, both of the packets P₁ and P₂ received before the packet P₃ have arrived at the reception node 3 without being significantly delayed, and the packet P₂, which has been received immediately before the packet P₃, has the largest data amount between the packets P₁ and P₂.

When the packet selection unit 11 selects and outputs any one of the packets included in the packet set 8 based on the delay time in this manner, a decoder 12 decodes data stored in the selected packet and outputs audio information X′ 13. With this, as compared with a case where only the packet generated at a single data rate is transmitted, the reception node 3 can decode the data encoded at a larger data rate that is determined depending on the congestion situation of the packet communication network to the audio information X′ 13.

Alternatively, the reception node 3 may transfer the packet selected by the packet selection unit 11 to another packet communication device via a packet transmission unit 14. A third node is a general packet communication device here. More specifically, the third node is preferably a wireless communication device for performing packet data communication, such as a mobile phone terminal, but may also be a server machine or a client device installed on the network such as the Internet. The third node does not need to select the packet unlike the second node, and decodes the received packet as it is.

In particular, a system including the third node is preferred in a case where a VoIP server is used to connect two portable terminals each executing a VoIP client to each other. In this case, the transmission node 2 corresponds to one of the portable terminals, the reception node 3 corresponds to the VoIP server, and the packet communication device as the transfer destination corresponds to the other of the portable terminals. A mode in which the packet selected by the reception node 3 is transferred to another node is described in more detail in a second embodiment of this invention.

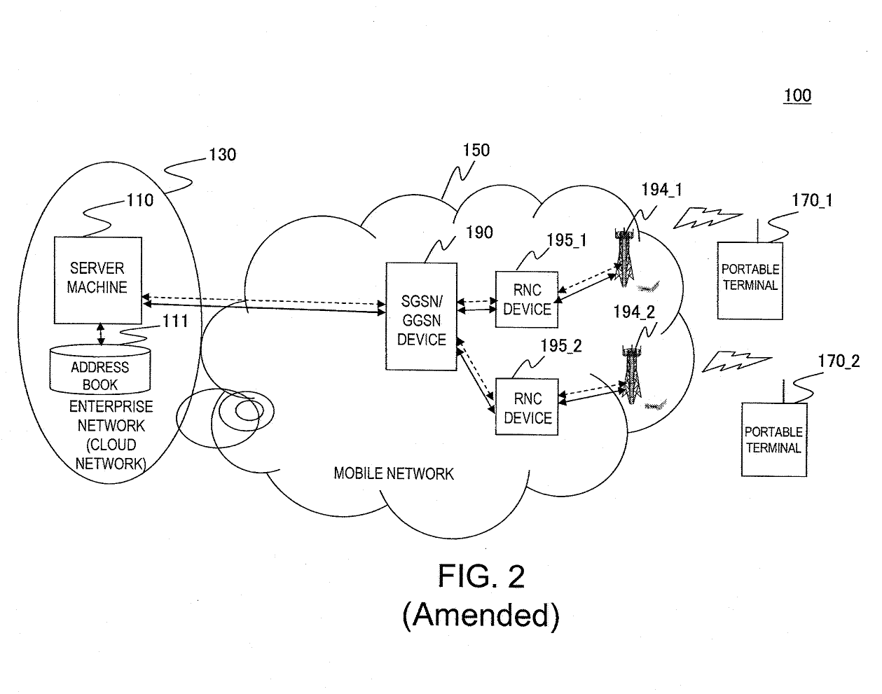

A description is given of a remote mobile communication system according to the second embodiment of this invention with reference to FIG. 2. FIG. 2 illustrates a configuration adopted in a case where a mobile 3G packet network is used as a network 150 serving as the packet communication network and an SGSN/GGSN device is used as a packet transfer device, but another network (such as mobile LTE network, Wi-Fi network, WiMAX network, IP network, NGN network, or the Internet) may also be used.

FIG. 2 illustrates an embodiment of this invention in a case where, when a portable terminal 170_1 is connected to a server machine 110 installed on a cloud network 130 to transfer screen data through use of a thin client, a voice call is made from the portable terminal 170_1 to a portable terminal 170_2 by using the server machine 110. The portable terminals 170_1 and 170_2 in this case are each a thin client terminal having installed therein client software for the thin client. Further, FIG. 2 illustrates a configuration in which both of the portable terminals are connected to the mobile network 150.

In this embodiment, the server 110 machine of the thin client holds address book data, in which user names, phone numbers, and the like are registered and which is necessary for making a phone call from the thin client terminal 170_1, and hence the terminal 170_1 does not need to hold the address book at any time. Accordingly, even if the terminal 170_1 is lost, it is possible to ensure the security for the phone numbers, the user names, and the like. In FIG. 2, an address book 111 in which the user names, the phone numbers, and the like are registered is prepared in advance and connected to the server machine 110.

FIG. 2 illustrates the following case. The portable terminal 170_1 is connected to the server machine 110. In order to start a voice call to the portable terminal 170_2, on a virtual client of the server machine 110, a screen data generated by activating a voice call VoIP application is transferred from the server 110 to the portable terminal 170_1. The screen data is decoded and displayed by the client software of the portable terminal 170_1, and then a user name is designated on the screen. The portable terminal 170_1 subsequently makes a voice call to the portable terminal 170_2.

In this case, in each of the portable terminals 170_1 and 170_2, the client software for causing each of the portable terminals to operate as the terminal of the thin client is installed. The client software is described later. It is assumed in this embodiment that a voice codec installed in the client software of each of the portable terminals 170_1 and 170_2 is, as an example, G.711 as the ITU-T standard. Specifically, the G.711 voice codec can refer to the ITU-T G.711 standard, for example. Note that, another well-known voice codec other than G.711 may also be used as the voice codec.

Referring back to FIG. 2, when the portable terminal 170_1 performs an operation of activating the voice call VoIP application on the virtual client of the server machine 110 in order to start a voice call, the packet storing an operation signal for activating the VoIP application is transmitted from the portable terminal 170_1 to the server machine 110. When the server machine 110 receives the packet storing the operation signal, a control unit determines that a voice call is being made and activates the voice call VoIP application on the virtual client, and generates a screen. The control unit then encodes information on the generated screen and transfers the encoded screen information from the server machine 110 to the portable terminal 170_1. The portable terminal 170_1 decodes the received screen information and displays the decoded screen information on the screen of the portable terminal 170_1. An end user then performs an operation such as selection of the other party's user name and phone number, which is the next action.

Note that, when the screen is accompanied with audio data, an audio signal accompanying the screen is processed through a path different from the path for the voice call. Specifically, after a screen capturing unit captures the screen, the audio signal is subjected to compression encoding by an audio encoder and formed into a compressed and encoded stream, and transmitted to the portable terminal 170_1 as a packet different from the packet for a voice call under a predetermined protocol.

After the above-mentioned processing, well-known packets are transmitted from the portable terminal 170_1. Specifically, those packets are a packet storing a session control message under a session control protocol and a packet storing a bit stream (code) obtained by the audio encoder installed in the client software of the portable terminal by compressing and encoding an audio signal. It is assumed here that the G.711 voice codec under the ITU-T standard is used as the voice codec, but another well-known voice codec such as Adaptive Multi-Rate (AMR) voice codec under the 3GPP standard may also be used. Further, Session Initiation Protocol (SIP) is used as the session control protocol as an example, but another well-known protocol may also be used.

Those packets arrive at a base station 194_1 on the mobile network 150 whose service range includes the portable terminal and arrives at the server machine 110 of the cloud network 130 via an RNC device 195_1 and an SGSN/GGSN device 190.

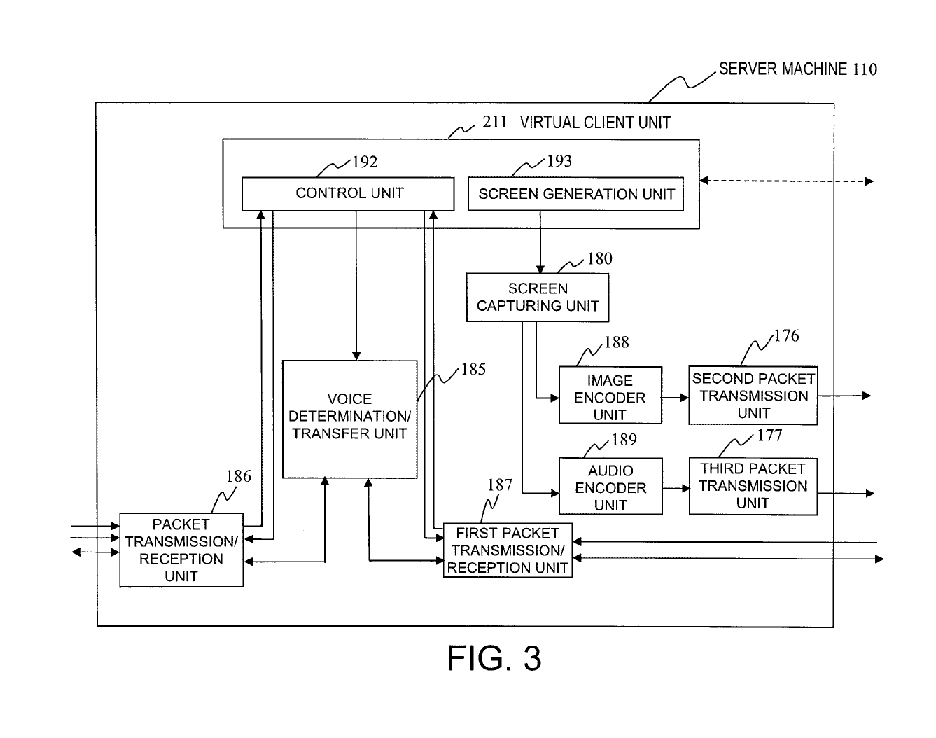

A description is next given of a configuration of the server machine 110 with reference to FIG. 3. FIG. 3 is a block diagram illustrating the configuration of the server machine 110. A virtual client unit 211 runs on a guest OS in a virtualized environment on a host OS, which is not shown in FIG. 3. Well-known OSes can be used as the host OS and the guest OS. It is assumed here as an example that Linux (trademark) and Android (trademark) are used as the host OS and the guest OS, respectively, but another OS such as Windows (trademark) may also be used.

In FIG. 3, the virtual client unit 211 includes a control unit 192 and a screen generation unit 193. To start a voice call, the portable terminal 170_1 illustrated in FIG. 2 stores in the packet the operation signal for activating the voice call VoIP application software on the virtual client and transmits the packet to the server machine 110. A packet transmission/reception unit 186 of the server machine 110 receives the packet storing the operation signal, extracts the operation signal from the packet, and outputs the extracted operation signal to the control unit 192.

The control unit 192 inputs the operation signal and executes the voice call VoIP application software when determining that the operation signal is a signal for activating the VoIP application software for a voice call. With this execution, the screen generation unit 193 generates the screen with the use of the application software and outputs the generated screen to a screen capturing unit 180. The screen capturing unit 180 captures the generated screen at a predetermined screen resolution and a predetermined frame rate and outputs the captured screen to an image encoder unit 188. The image encoder unit 188 uses a predetermined image encoder to compress and encode the input screen at a predetermined screen resolution, a predetermined bit rate, and a predetermined frame rate to acquire a compressed and encoded stream, and outputs the compressed and encoded stream to a second packet transmission unit 176. A well-known image compression encoding scheme such as H.264, MPEG-4, or JPEG 2000 can be used as the image compression encoding scheme to be used in this case.

The second packet transmission unit 176 stores the compressed and encoded stream input from the image encoder unit 188 in a predetermined packet and outputs the packet to the SGSN/GGSN device 190 illustrated in FIG. 2. A protocol for the packet in this case may be RTP/UDP/IP, UDP/IP, or TCP/IP. It is assumed here that UDP/IP is used as an example.

The portable terminal 170_1 of FIG. 2 next receives the compressed and encoded stream, decodes the received compressed and encoded stream at a predetermined screen resolution and a predetermined frame rate, and displays the decoded stream on the portable terminal 170_1 itself.

Referring back to FIG. 3, the control unit 192 reads from the address book 111 of FIG. 2 the other party's user name (in this case, a user who holds the terminal 175) and the other party's phone number (in this case, the phone number of the portable terminal 170_2). The screen generation unit 193 generates the screen, and the image encoder 188 compresses and encodes the generated screen to be transmitted to the portable terminal 170. On the portable terminal 170, the user and his/her phone number are selected while the transmitted screen is viewed on the terminal. Then, when a voice call is started, the portable terminal 170_1 transmits to the server machine 110 the packet storing a SIP message notifying that a voice call is to be started, and subsequently, transmits to the server machine 110 a voice signal in the form of the packets storing the bit streams having a plurality of kinds of bit rates, which are subjected to the compression encoding by the G.711 voice encoder installed in the client software.

The server machine 110 processes the packet relating to a voice call with the use of the path different from the path for the audio signal accompanying the screen, to thereby reduce a delay of the voice call.

The packet transmission/reception unit 186 outputs, from among the packets received from the portable terminal 170_1, the packet storing the SIP message to the control unit 192, and outputs the packets storing the compressed and encoded bit streams having the plurality of kinds of bit rates for the audio information to a voice determination/transfer generation unit 185.

Further, a first packet transmission/reception unit 187 outputs, among the packets received from the portable terminal 170_2, the packet storing the SIP message to the control unit 192, and outputs the packets storing the compressed and encoded bit streams having the plurality of kinds of bit rates for the audio information to the voice determination/transfer generation unit 185.

The control unit 192 performs the following operation when receiving the operation signal from the packet transmission/reception unit 186. (1) The control unit 192 analyzes the operation signal and activates the voice call VoIP application software when the operation signal indicates the operation of activating a voice call. (2) In the case of a voice call, the control unit 192 receives the SIP message from the packet transmission/reception unit 186. (3) The control unit 192 obtains, from the VoIP application software, the other party's phone number selected by the end user and acquires the other party's IP address from the phone number. (4) The control unit 192 rewrites the other party's IP address of the received SIP message to the IP address acquired in (3), and then outputs the rewritten SIP message and the other party's IP address to the first packet transmission/reception unit 187. (5) The control unit 192 inputs, from the packet transmission/reception unit 186, Session Description Protocol (SDP) from the portable terminal 170_1, and checks performance information on the voice codec installed in the client software of the portable terminal 170_1. It is assumed in this case that the G.711 voice codec is used as the voice codec as described above. The control unit 192 further inputs, from the first packet transmission/reception unit 187, Session Description Protocol (SDP) from the portable terminal 170_2, and checks performance information on the voice codec) installed in the terminal 170_2. In this case, the G.711 voice codec is used as the voice codec of the portable terminal 170_2 as described above, and hence the performance information matches that of the portable terminal 170_1. Transcoding or the like is therefore not necessary. (6) The control unit 192 issues the following instructions to the voice determination/transfer generation unit 185: an instruction to measure the delay times of the voice compressed and encoded bit streams having the plurality of bit rates that have been transmitted from the portable terminal 170_1 and received by the packet transmission/reception unit 186, extract the bit stream having the bit rate corresponding to the bit stream received immediately before the delay time increases, and discard the bit streams having other bit rates; an instruction to further transfer the extracted bit stream to the first packet transmission/reception device 187; and an instruction to perform similar determination on the bit streams having the plurality of bit rates for the audio information, which have been transmitted from the portable terminal 170_2 and received by the first packet transmission/reception unit 187, and transfer the extracted bit stream to the packet transmission/reception unit 186.

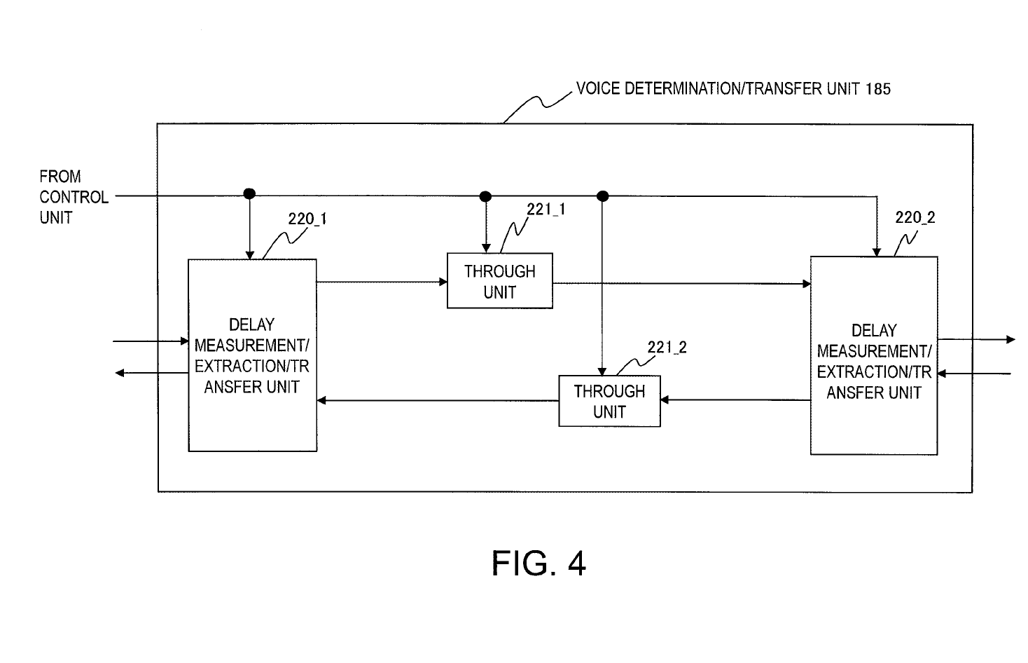

A description is next given of a configuration of the voice determination/transfer unit 185 with reference to FIG. 4. Referring to FIG. 4, a description is first given of a flow of a signal for a voice call that is made in a direction from the portable terminal 170_1 to the portable terminal 170_2. A delay measurement/extraction/transfer unit 220_1 inputs, from the packet transmission/reception unit 186, the compressed and encoded bit streams having the plurality of bit rates that have been transmitted from the portable terminal 170_1. It is assumed in this case that, as described later, the bit streams having five kinds of bit rates are transmitted from the client software of the portable terminal 170_1. Those bit rates are, specifically, 32 kbps, 40 kbps, 48 kbps, 56 kbps, and 64 kbps, and in this stated order of the bit rates, the pieces of data having the respective bit rates are stored in independent five kinds of packets, and the five kinds of packets are consecutively transmitted at time intervals of 20 ms, for example.

The delay measurement/extraction/transfer unit 220_1 receives the instruction from the control unit 192 of FIG. 3, and in accordance with the following Expression 1, measures respective arrival delay times of the five kinds of packets storing the compressed and encoded bit streams having the respective bit rates corresponding to the above-mentioned five kinds of bit rates.

Dj=R(j)−S(j) (Expression 1)

where Dj, R(j), and S(j) represent a delay time of a j-th packet, a reception time of the j-th packet, and a transmission time at which the j-th packet is transmitted by the portable terminal 170_1, respectively.

The delay measurement/extraction/transfer unit 220_1 compares the delay times Dj (1≦j≦5) calculated by Expression 1 with one another in the order of D1 to D5, and acquires Dj corresponding to the time at which the delay time starts to increase. For example, when it is assumed that the delay times of D1 to D4 are about 100 ms and the delay time of D5 increases to 150 ms, D5 corresponds to the packet at which the delay time starts to increase. The delay measurement/extraction/transfer unit 220_1 then extracts the bit stream stored in the packet that has been received immediately before the delay time increases. In other words, in this example, the delay measurement/extraction/transfer unit 220_1 extracts the bit stream of the fourth packet, that is, the bit stream having the bit rate of 56 kbps, and outputs the extracted bit stream every 20 ms, for example.

A through unit 221_1 receives the instruction from the control unit 192 and inputs the bit stream extracted by the delay measurement/extraction/transfer unit 220_1 every 20 ms, for example, and outputs the input bit stream to a delay measurement/extraction/transfer unit 220_2 while passing the bit stream therethrough.

The delay measurement/extraction/transfer/transfer unit 220_2 transmits the bit stream data having the extracted bit rate to the first packet transmission/reception unit 187 of FIG. 3. Next, to describe an operation of a voice call in the opposite direction (direction from the portable terminal 170_2 to the portable terminal 170_1), it is only necessary to follow the above-mentioned processing in the opposite direction, and hence a description thereof is omitted.

Referring back to FIG. 2, the first packet transmission/reception unit 187 inputs from the control unit 192 the other party's IP address and the SIP message and inputs the bit stream data having the extracted bit rate, which has been output from the voice determination/transfer unit 185 every 20 ms, for example. The first packet transmission/reception unit 187 stores the bit stream data in the packet having a predetermined protocol, and outputs the packet toward the portable terminal 170_2 via the mobile network of FIG. 2. RTP/UDP/IP is used in this case as the predetermined protocol, but another well-known protocol may also be used.

In the case of the voice call in the opposite direction, the packet transmission/reception unit 186 inputs the bit stream data having the extracted bit rate every 20 ms, for example, stores the bit stream data in the packet having the predetermined protocol, and outputs the packet toward the portable terminal 170_1 via the mobile network of FIG. 2. RTP/UDP/IP is used in this case as the predetermined protocol, but another well-known protocol may also be used.

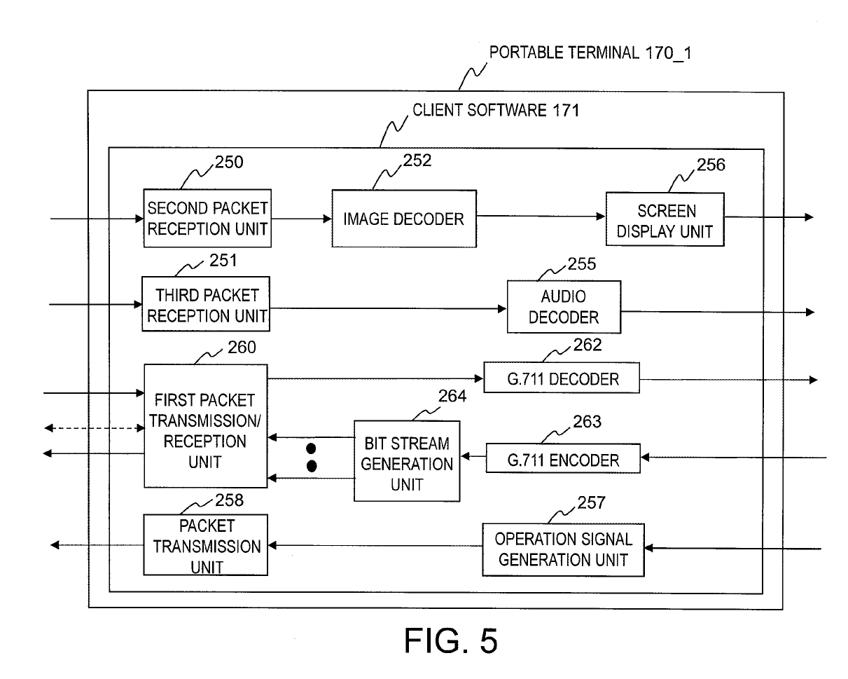

A description is next given of a configuration of the portable terminal 170_1, which is the client of the thin client, with reference to FIG. 5. The portable terminal 170_2 has the same configuration as that of the portable terminal 170_1 here, and hence the configuration of the portable terminal 170_1 is described as a representative. In FIG. 5, the portable terminal 170_1 has the client software 171 installed therein, thereby executing the operation of the client of the thin client. It is assumed here that, as described above, the G.711 voice codec is installed in the thin client software as the voice codec.

In FIG. 5, in the case of a voice call, when a user performs an operation on the screen of the portable terminal in order to activate the voice call VoIP application software on the screen, an operation signal generation unit 257 generates the operation signal for activation and a packet transmission unit 258 packetizes the operation signal and transmits the packet from the portable terminal 170_1 to the mobile network 150.

A first packet transmission/reception unit 260 inputs the SIP/SDP message and the packet storing the voice bit stream having the extracted bit rate, which have been transmitted from the server machine 110, and extracts the voice bit stream from the packet and outputs the extracted voice bit stream to a G.711 decoder 262.

The G.711 decoder 262 inputs the G.711 bit stream having the bit rate of 56 kbps, which is the bit rate extracted by the voice determination/transfer unit 185 of FIG. 3, every predetermined time interval, for example, every 20 ms, and decodes and outputs the input bit stream.

A G.711 encoder 263 performs G.711 encoding processing on a voice input signal every predetermined time interval, for example, every 20 ms, generates the bit stream having the bit rate of 64 kbps, and outputs the generated bit stream to a bit rate generation unit 264.

The bit stream generation unit 264 inputs the bit stream having the bit rate of 64 kbps every 20 ms, for example, and generates the bit streams having predetermined kinds of bit rates every 20 ms, for example. In this case, as described above, the bit stream generation unit 264 generates the bit streams having the five kinds of bit rates in total. The five kinds of bit rates are, specifically, 64 kbps, 56 kbps, 48 kbps, 40 kbps, and 32 kbps, and the bit stream generation unit 264 generates the bit streams having four kinds of bit rates, that is, 56 kbps, 48 kbps, 40 kbps, and 32 kbps.

A specific generation method is described next. First, the bit stream generation unit 264 inputs the bit stream having the bit rate of 64 kbps, which is the original bit rate. This bit stream is a stream having 8 bits per sample, which is obtained by sampling, and hence by performing processing of reducing the bits per sample by 1 bit, 2 bit, 3 bit, and 4 bit, it is possible to generate the bit streams having the bit rates of 56 kbps, 48 kbps, 40 kbps, and 32 kbps, respectively, with an extremely little processing amount. The bit stream generation unit 264 outputs the bit streams having the five kinds of bit rates in total to the first packet transmission/reception unit 260 every 20 ms, for example.

The first packet transmission/reception unit 260 inputs from the bit stream generation unit 264 the bit streams having the five kinds of bit rates every 20 ms, for example, stores the respective bit streams in independent packets, and consecutively transmits those packets to the mobile network 150 within 20 ms in a predetermined order at short time intervals. It is assumed that the predetermined order in this case is, as an example, an ascending order of the bit rate, that is, the order of 32 kbps, 40 kbps, 48 kbps, 56 kbps, and 64 kbps. It is assumed that the time interval for the packet is, for example, about 1 ms.

A second packet reception unit 250 inputs the compressed and encoded bit stream obtained by compressing and encoding a screen signal, decodes the compressed and encoded bit stream with the use of the same image codec as that of the server machine 110, and outputs the decoded screen signal to a screen display unit 256.

The screen display unit 256 inputs the decoded screen signal, builds the screen, and displays the screen on the screen of the portable terminal.

When there is an audio signal accompanying the screen, a third packet reception unit 251 inputs the packet storing the compressed and encoded bit stream obtained by compressing and encoding the audio signal, extracts the compressed and encoded bit stream obtained by compressing and encoding the audio signal, and outputs the extracted compressed and encoded bit stream to an audio decoder 255.

The audio decoder 255 inputs the compressed and encoded bit stream obtained by compressing and encoding the audio signal, decodes the compressed and encoded bit stream, and outputs the decoded bit stream from a speaker of the portable terminal 170.

This invention is described above by way of the embodiments, but this invention is not limited to the embodiments described above. For example, the case where the mobile 3G network is used as the network 150 is described above in the second embodiment, but a mobile Long Term Evolution (LTE) network may also be used. Alternatively, a fixed network, a next generation network (NGN), a W-LAN network, or the Internet may also be used. A fixed terminal may also be used in place of the portable terminal.

Further, instead of in the enterprise network, the server machine 110 may also be disposed in the mobile network or the fixed network.

Further, the server machine may also be disposed in any one of the mobile network and the fixed network.

Further, a smartphone or a tablet computer may also be used as the portable terminal 170.

Further, another well-known voice codec may also be used as the voice codec.

Further, a method other than Expression (1) may also be used for the calculation of the delay time by the voice determination/transfer unit 185.

Part or whole of the above-mentioned embodiments can also be described as the following supplementary notes. However, the following supplementary notes are not intended to limit this invention.

### (Supplementary Note 1)

A packet communication system, including:

a first node; and

a second node,

the first node including:
packet generation means for encoding audio information to be transmitted to generate a plurality of packets P₁, P₂, . . . , Pₘ, the plurality of packets P₁, P₂, . . . , Pₘ each corresponding to the audio information and having data amounts q₁, q₂, . . . , qₘ, respectively, that satisfy a relationship of q₁<q₂< . . . <qₘ, where m is a natural number of 2 or more; and
packet transmission means for transmitting the plurality of packets P₁, P₂, . . . , Pₘ to the second node, which is different from the first node, via a packet communication network,

the second node including:
delay time measurement means for measuring delay times t₁, t₂, . . . , tₘ of the plurality of packets P₁, P₂, . . . , Pₘ, respectively; and
packet selection means for selecting any one of the plurality of packets P₁, P₂, . . . , Pₘ based on the delay times t₁, t₂, . . . , tₘ.

### (Supplementary Note 2)

A system according to Supplementary Note 1,

in which the packet transmission means transmits the plurality of packets P₁, P₂, . . . , Pₘ in ascending order of the data amounts, and

in which the packet selection means determines, every time each of the plurality of packets is received, whether or not the each of the plurality of packets is valid based on the delay time of the each of the plurality of packets, and when determining that the each of the plurality of packets is invalid, selects one of the plurality of packets that has been received immediately before the each of the plurality of packets.

### (Supplementary Note 3)

A system according to Supplementary Note 1 or 2, further including a third node, which is different from both of the first node and the second node,

in which the second node further includes means for transmitting the selected one of the plurality of packets to the third node.

### (Supplementary Note 4)

A system according to any one of Supplementary Notes 1 to 4, in which the second node further includes decoding means for decoding the audio information based on the selected one of the plurality of packets.

### (Supplementary Note 5)

A packet communication device, including:

packet reception means for receiving a plurality of packets P₁, P₂, . . . , Pₘ via a packet communication network, the plurality of packets P₁, P₂, . . . , Pm each corresponding to the audio information, each of the audio information to be transmitted being encoded to the plurality of packets P₁, P₂, . . . , Pₘ, and the plurality of packets P₁, P₂, . . . , Pₘ having data amounts q₁, q₂, . . . , qₘ, respectively, that satisfy a relationship of q₁<q₂< . . . <qₘ, where m is a natural number of 2 or more;

delay time measurement means for measuring delay times t₁, t₂, . . . , tₘ of the plurality of packets P₁, P₂, . . . , Pₘ, respectively; and

packet selection means for selecting any one of the plurality of packets P₁, P₂, . . . , Pₘ based on the delay times t₁, t₂, . . . , tₘ.

### (Supplementary Note 6)

A packet communication device according to Supplementary Note 5,

in which the packet reception means receives the plurality of packets P₁, P₂, . . . , Pₘ in ascending order of the data amounts, and

in which the packet selection means determines, every time each of the plurality of packets is received, whether or not the each of the plurality of packets is valid based on the delay time of the each of the plurality of packets, and when determining that the each of the plurality of packets is invalid, selects one of the plurality of packets that has been received immediately before the each of the plurality of packets.

### (Supplementary Note 7)

A packet communication device according to Supplementary Note 5 or 6, further including means for transferring the selected one of the plurality of packets to the another packet communication device.

### (Supplementary Note 8)

A packet communication device according to any one of Supplementary Notes 5 to 7, further including decoding means for decoding the audio information based on the selected one of the plurality of packets.

### (Supplementary Note 9)

A packet communication device, including:

packet generation means for encoding audio information to be transmitted to generate a plurality of packets P₁, P₂, . . . , Pₘ, the plurality of packets P₁, P₂, . . . , Pₘ each corresponding to the audio information and having data amounts q₁, q₂, . . . , qₘ, respectively, that satisfy a relationship of q₁<q₂< . . . <qₘ, where m is a natural number of 2 or more; and

packet transmission means for transmitting the plurality of packets P₁, P₂, . . . , Pₘ to a destination packet communication device, which is different from the packet communication device, via a packet communication network,

in which the destination packet communication device is configured to:
measure delay times t₁, t₂, . . . , tₘ of the plurality of packets P₁, P₂, . . . , Pₘ, respectively;
select any one of the plurality of packets P₁, P₂, . . . , Pₘ based on the delay times t₁, t₂, . . . , tₘ; and
decode the audio information based on the selected one of the plurality of packets.

### (Supplementary Note 10)

A packet communication device according to Supplementary Note 9,

in which the packet transmission means transmits the plurality of packets P₁, P₂, . . . , Pₘ in ascending order of the data amounts, and

in which the destination packet communication device determines, every time each of the plurality of packets is received, whether or not the each of the plurality of packets is valid based on the delay time of the each of the plurality of packets, and when determining that the each of the plurality of packets is invalid, selects one of the plurality of packets that has been received immediately before the each of the plurality of packets.

### (Supplementary Note 11)

A program for causing a computer to function as:

packet reception means for receiving a plurality of packets P₁, P₂, . . . , Pₘ via a packet communication network, the plurality of packets P₁, P₂, . . . , Pm each corresponding to the audio information, each of the audio information to be transmitted being encoded to the plurality of packets P₁, P₂, . . . , Pₘ, and the plurality of packets P₁, P₂, . . . , Pₘ having data amounts q₁, q₂, . . . , qₘ, respectively, that satisfy a relationship of q₁<q₂< . . . <qₘ, where m is a natural number of 2 or more;

delay time measurement means for measuring delay times t₁, t₂, . . . , tₘ of the plurality of packets P₁, P₂, . . . , Pₘ, respectively; and

packet selection means for selecting any one of the plurality of packets P₁, P₂, . . . , Pₘ based on the delay times t₁, t₂, . . . , tₘ.

### (Supplementary Note 12)

A program according to Supplementary Note 11,

in which the packet reception means receives the plurality of packets P₁, P₂, . . . , Pₘ in ascending order of the data amounts, and

in which the packet selection means determines, every time each of the plurality of packets is received, whether or not the each of the plurality of packets is valid based on the delay time of the each of the plurality of packets, and when determining that the each of the plurality of packets is invalid, selects one of the plurality of packets that has been received immediately before the each of the plurality of packets.

### (Supplementary Note 13)

A program according to Supplementary Note 11 or 12, further causing the computer to function as means for transferring the selected one of the plurality of packets to the another packet communication device.

### (Supplementary Note 14)

A program according to any one of Supplementary Notes 11 to 13, further causing the computer to function as decoding means for decoding the audio information based on the selected one of the plurality of packets.

### (Supplementary Note 15)

A program for causing a computer to function as:

packet generation means for encoding audio information to be transmitted to generate a plurality of packets P₁, P₂, . . . , Pₘ, the plurality of packets P₁, P₂, . . . , Pₘ each corresponding to the audio information and having data amounts q₁, q₂, . . . , qₘ, respectively, that satisfy a relationship of q₁<q₂< . . . <qₘ, where m is a natural number of 2 or more; and

packet transmission means for transmitting the plurality of packets P₁, P₂, . . . , Pₘ to a destination packet communication device, which is different from the packet communication device, via a packet communication network,

in which the destination packet communication device is configured to:
measure delay times t₁, t₂, . . . , tₘ of the plurality of packets P₁, P₂, . . . , Pₘ, respectively; and
select any one of the plurality of packets P₁, P₂, . . . , Pₘ based on the delay times t₁, t₂, . . . , tₘ.

### (Supplementary Note 16)

A program according to Supplementary Note 15,

in which the packet transmission means transmits the plurality of packets P₁, P₂, . . . , Pₘ in ascending order of the data amounts, and

in which the destination packet communication device determines, every time each of the plurality of packets is received, whether or not the each of the plurality of packets is valid based on the delay time of the each of the plurality of packets, and when determining that the each of the plurality of packets is invalid, selects one of the plurality of packets that has been received immediately before the each of the plurality of packets.

### (Supplementary Note 17)

A method of transmitting audio information, including, when transmitting audio information from a first node to a second node via a packet communication network:

a packet generation step of encoding, by the first node, audio information to be transmitted to generate a plurality of packets P₁, P₂, . . . , Pₘ, the plurality of packets P₁, P₂, . . . , Pₘ each corresponding to the audio information and having data amounts q₁, q₂, . . . , qₘ, respectively, that satisfy a relationship of q₁<q₂< . . . <qₘ, where m is a natural number of 2 or more;

a packet transmission step of transmitting the plurality of packets P₁, P₂, . . . , Pₘ from the first node to the second node via the packet communication network;

a delay time measurement step of measuring, by the second node, delay times t₁, t₂, . . . , tₘ of the plurality of packets P₁, P₂, . . . , Pₘ, respectively; and

a packet selection step of selecting, by the second node, any one of the plurality of packets P₁, P₂, . . . , Pₘ based on the delay times t₁, t₂, . . . , tₘ.

### (Supplementary Note 18)

A method according to Supplementary Note 17,

in which the packet transmission step includes transmitting the plurality of packets P₁, P₂, . . . , Pₘ in ascending order of the data amounts, and

in which the packet selection step includes determining, every time each of the plurality of packets is received, whether or not the each of the plurality of packets is valid based on the delay time of the each of the plurality of packets, and when determining that the each of the plurality of packets is invalid, selecting one of the plurality of packets that has been received immediately before the each of the plurality of packets.

### (Supplementary Note 19)

A method according to Supplementary Note 17 or 18, further including transmitting the selected one of the plurality of packets from the second node to a third node, which is different from both of the first node and the second node.

### (Supplementary Note 20)

A method according to any one of Supplementary Notes 17 to 19, further including a decoding step of decoding, by the second node, the audio information based on the selected one of the plurality of packets.

This application is based on and claims the benefit of priority from Japanese Patent Application No. 2012-214530, filed on Sep. 27, 2012, the disclosure of which is incorporated herein in its entirety.

1. A packet communication system, comprising:
a first node; and
a second node,
the first node comprising:
packet generation means for encoding audio information to be transmitted to generate a plurality of packets P₁, P₂, . . . , Pₘ, the plurality of packets P₁, P₂, . . . , Pₘ each corresponding to the audio information and having data amounts q₁, q₂, . . . , qₘ, respectively, that satisfy a relationship of q₁<q₂< . . . <qₘ, where m is a natural number of 2 or more; and
packet transmission means for transmitting the plurality of packets P₁, P₂, . . . , Pₘ to the second node, which is different from the first node, via a packet communication network,
the second node comprising:
delay time measurement means for measuring delay times t₁, t₂, . . . , tₘ of the plurality of packets P₁, P₂, . . . , Pₘ, respectively; and
packet selection means for selecting any one of the plurality of packets P₁, P₂, . . . , Pₘ based on the delay times t₁, t₂, . . . , tₘ.

2. A system according to claim 1,
wherein the packet transmission means transmits the plurality of packets P₁, P₂, . . . , Pₘ in ascending order of the data amounts, and
wherein the packet selection means determines, every time each of the plurality of packets is received, whether or not the each of the plurality of packets is valid based on the delay time of the each of the plurality of packets, and when determining that the each of the plurality of packets is invalid, selects one of the plurality of packets that has been received immediately before the each of the plurality of packets.

3. A system according to claim 1, further comprising a third node, which is different from both of the first node and the second node,
wherein the second node further comprises means for transmitting the selected one of the plurality of packets to the third node.

4. A system according to claim 1, wherein the second node further comprises decoding means for decoding the audio information based on the selected one of the plurality of packets.

5. A packet communication device, comprising:
packet reception means for receiving a plurality of packets P₁, P₂, . . . , Pₘ via a packet communication network, the plurality of packets P₁, P₂, . . . , Pm each corresponding to the audio information, each of the audio information to be transmitted being encoded to the plurality of packets P₁, P₂, . . . , Pₘ, and the plurality of packets P₁, P₂, . . . , Pₘ having data amounts q₁, q₂, . . . , qₘ, respectively, that satisfy a relationship of q₁<q₂< . . . <qₘ, where m is a natural number of 2 or more;
delay time measurement means for measuring delay times t₁, t₂, . . . , tₘ of the plurality of packets P₁, P₂, . . . , Pₘ, respectively;
packet selection means for selecting any one of the plurality of packets P₁, P₂,. . . , Pₘ based on the delay times t₁, t₂, . . . , tₘ; and
decoding means for decoding the audio information based on the selected one of the plurality of packets.

6. A packet communication device according to claim 5,
wherein the packet reception means receives the plurality of packets P₁, P₂, . . . , Pₘ in ascending order of the data amounts, and
wherein the packet selection means determines, every time each of the plurality of packets is received, whether or not the each of the plurality of packets is valid based on the delay time of the each of the plurality of packets, and when determining that the each of the plurality of packets is invalid, selects one of the plurality of packets that has been received immediately before the each of the plurality of packets.

7. A packet communication device, comprising:
packet generation means for encoding audio information to be transmitted to generate a plurality of packets P₁, P₂, . . . , Pₘ, the plurality of packets P₁, P₂, . . . , Pₘ each corresponding to the audio information and having data amounts q₁, q₂, . . . , qₘ, respectively, that satisfy a relationship of q₁<q₂< . . . <qₘ, where m is a natural number of 2 or more; and
packet transmission means for transmitting the plurality of packets P₁, P₂, . . . , Pₘ to a destination packet communication device, which is different from the packet communication device, via a packet communication network,
wherein the destination packet communication device is configured to:
measure delay times t₁, t₂, . . . , tₘ of the plurality of packets P₁, P₂, . . . , Pₘ, respectively; and
select any one of the plurality of packets P₁, P₂, . . . , Pₘ based on the delay times t₁, t₂, . . . , tₘ.

8. A program for causing a computer to function as:
packet reception means for receiving a plurality of packets P₁, P₂, . . . , Pₘ via a packet communication network, the plurality of packets P₁, P₂, . . . , Pm each corresponding to the audio information, each of the audio information to be transmitted being encoded to the plurality of packets P₁, P₂, . . . , Pₘ, and the plurality of packets P₁, P₂, . . . , Pₘ having data amounts q₁, q₂, . . . qₘ, respectively, that satisfy a relationship of q₁<q₂< . . . <qₘ, where m is a natural number of 2 or more;
delay time measurement means for measuring delay times t₁, t₂, . . . , tₘ of the plurality of packets P₁, P₂, . . . , Pₘ, respectively; and
packet selection means for selecting any one of the plurality of packets P₁, P₂, . . . , Pₘ based on the delay times t₁, t₂, . . . , tₘ.

9. A program for causing a computer to function as:
packet generation means for encoding audio information to be transmitted to generate a plurality of packets P₁, P₂, . . . , Pₘ, the plurality of packets P₁, P₂, . . . , Pₘ each corresponding to the audio information and having data amounts q₁, q₂, . . . , qₘ, respectively, that satisfy a relationship of q₁<q₂< . . . <qₘ, where m is a natural number of 2 or more; and
packet transmission means for transmitting the plurality of packets P₁, P₂, . . . , Pₘ to a destination packet communication device, which is different from the packet communication device, via a packet communication network,
wherein the destination packet communication device is configured to:
measure delay times t₁, t₂, . . . , tₘ of the plurality of packets P₁, P₂, . . . , Pₘ, respectively; and
select any one of the plurality of packets P₁, P₂, . . . , Pₘ based on the delay times t₁, t₂, . . . , tₘ.

10. A method of transmitting audio information, comprising, when transmitting audio information from a first node to a second node via a packet communication network:
a packet generation step of encoding, by the first node, audio information to be transmitted to generate a plurality of packets P₁, P₂, . . . , Pₘ, the plurality of packets P₁, P₂, . . . , Pₘ each corresponding to the audio information and having data amounts q₁, q₂, . . . , qₘ, respectively, that satisfy a relationship of q₁<q₂< . . . <qₘ, where m is a natural number of 2 or more;
a packet transmission step of transmitting the plurality of packets P₁, P₂, . . . , Pₘ from the first node to the second node via the packet communication network;
a delay time measurement step of measuring, by the second node, delay times t₁ , t₂, . . . , tₘ of the plurality of packets P₁, P₂, . . . , Pₘ, respectively; and
a packet selection step of selecting, by the second node, any one of the plurality of packets P₁, P₂, . . . , Pₘ based on the delay times t₁, t₂, . . . , tₘ.
